(19) United States
(12) Patent Application Publication
(10) Pub. No.: US 2014/0085629 A1
(43) Pub. Date: Mar. 27, 2014

(54) Active Hyperspectral Imaging Systems

(71) Applicant: Bodkin Design & Engineering, LLC, Needham, MA (US)

(72) Inventors: Andrew Bodkin, Dover, MA (US); James T. McCann, Marlow, NH (US)

(73) Assignee: Bodkin Design & Engineering, LLC, Needham, MA (US)

(21) Appl. No.: 14/040,508

(22) Filed: Sep. 27, 2013

Related U.S. Application Data
(60) Provisional application No. 61/706,520, filed on Sep. 27, 2012.

(51) Int. Cl. G01J 3/28

(52) U.S. Cl. CPC G01J 3/2823
USPC 356/300

(57) ABSTRACT

An active hyperpixel array imaging system including a hyperspectral analyzer; an active spatial light modulator dynamically configurable to direct light, from at least a portion of a field of view of the hyperpixel array imaging system, towards the hyperspectral analyzer for capture of a two-dimensional image including spectral information; and imaging optics for forming an intermediate image, of the field of view on the active spatial light modulator. A method for performing spectral analysis of a field of view, the method including forming an intermediate image of the field of view on an active spatial light modulator; directing light from at least a portion of the field of view, using an active spatial light modulator, towards a hyperspectral analyzer; and capturing a hyperspectral image of the portion of the field of view, using the hyperspectral analyzer, the hyperspectral image including spectral information for the portion of the field of view.

### CROSS-REFERENCE TO RELATED APPLICATIONS

The present application claims the benefit of priority to U.S. Provisional Application No. 61/706,520 filed Sep. 27, 2012, which is incorporated herein by reference in its entirety.

### U.S. GOVERNMENT RIGHTS

The U.S. Government has certain rights in this invention as provided for by the terms of Contract # HQ0006-06-C-7308 awarded by the Missile Defense Agency.

### BACKGROUND

Hyperspectral imaging systems provide spatial and spectral information about a scene. Hyperspectral imaging is utilized in remote sensing, measurement, and detection in diverse fields such as agriculture, astronomy, geophysical science, and marine science. Objects viewed by hyperspectral imaging are often displayed in three dimensions as so-called hyperspectral cubes. The three dimensions of a hyperspectral cube are x and y for spatial information, and λ (wavelength) for spectral information. In an application, such as remote sensing of minerals, hyperspectral imaging is used to generate a spatial map of a property of interest, e.g., the mineralogical composition, where the mineralogical composition is deduced from the spectral data. In other applications, the spectral information helps identify objects that are too distant for proper identification through spatial images alone.

Typically, hyperspectral imaging involves either (a) sequentially capturing a series of spatial images, each spatial image representing a certain spectral component, or (b) sequentially capturing a series of spectral profiles, each spectral profile representing a certain spatial portion. In both cases, an element of the hyperspectral imaging system, such as a slit, mirror, or filter device, is physically moved to perform a scan over either the spectral dimension or the spatial dimensions. The data from the scan is combined, post-capture, to form a hyperspectral cube.

Current scanning spectrometer designs have resulted in large, expensive, and complex devices that are unsuitable for hand-held or vehicle applications. While these spectrometers have been employed effectively in airborne and satellite applications, they have inherent design limitations. For example, if relative motion between the platform holding the device and the object or area of interest is faster than the scan rate of the spectrometer, the data captured during a scan is mismatched, resulting in reduced quality of the hyperspectral data cube.

### SUMMARY

An active hyperpixel array imaging system including (a) a hyperspectral analyzer, (b) an active spatial light modulator that is dynamically configurable to direct light, from at least a portion of a field of view of the hyperpixel array imaging system, towards the hyperspectral analyzer for capture of a two-dimensional image including spectral information, and (c) imaging optics for forming an intermediate image, of the field of view on the active spatial light modulator.

A method for performing hyperspectral analysis of a field of view, where the method includes (a) forming an intermediate image of the field of view on an active spatial light modulator, (b) directing light from at least a portion of the field of view, using an active spatial light modulator, towards a hyperspectral analyzer, and (c) capturing a two-dimensional image of the portion of the field of view, using the hyperspectral analyzer, where the two-dimensional image includes spectral information for the portion of the field of view.

### BRIEF DESCRIPTION OF THE DRAWINGS

FIG. 1 illustrates one exemplary active hyperpixel array imaging system including an active spatial light modulator and a hyperspectral analyzer, according to an embodiment.

FIG. 2 illustrates one exemplary active hyperpixel array imaging system including an active spatial light modulator and a hyperspectral analyzer, according to an embodiment.

FIG. 3 illustrates one exemplary method for capturing two-dimensional images containing spectral information using an active hyperpixel array imaging system, according to an embodiment.

FIG. 4 illustrates one exemplary active system, including a spatial light modulator having an array of discrete elements, for controlling the propagation of incident light, according to an embodiment.

FIG. 5 illustrates one exemplary active hyperpixel array imaging system including an active spatial light modulator for reflecting light towards a hyperspectral analyzer, according to an embodiment.

FIG. 6 illustrates one exemplary active hyperpixel array imaging system including an active spatial light modulator for reflecting light towards a hyperspectral analyzer and/or an alternate analyzer, according to an embodiment.

FIG. 7 illustrates one exemplary active hyperpixel array imaging system including an active spatial light modulator that operates in transmission mode, according to an embodiment.

FIG. 8 illustrates one exemplary active spatial light modulator, according to an embodiment.

FIG. 9 illustrates one exemplary active hyperpixel array imaging system including an active spatial light modulator, operating in reflection mode, and a hyperspectral analyzer, according to an embodiment.

FIG. 10 is a diagram illustrating, for one exemplary active spatial light modulator including an array of discrete elements, the correspondence between the array of discrete elements and an image, forming a hyperpixel array, generated by a hyperspectral analyzer, according to an embodiment.

FIG. 11 illustrates one exemplary method for generating hyperspectral data by scanning over a region of interest using an active hyperpixel array imaging system, according to an embodiment.

FIG. 12 is a diagram illustrating, for one exemplary active spatial light modulator including an array of discrete elements, the correspondence between the array of discrete elements and an image, forming a hyperpixel array, generated by a hyperspectral analyzer, according to an embodiment.

FIG. 13 illustrates one exemplary method for parallel operation of a hyperspectral analyzer and an alternate analyzer, using an active hyperpixel array imaging system, according to an embodiment.

FIG. 14 illustrates one exemplary method for multiplexed operation of a hyperspectral analyzer and an alternate analyzer to interrogate the same portion of a field of view, using an active hyperpixel array imaging system, according to an embodiment.

FIG. 15 illustrates one exemplary adaptation of the method of FIG. 144 to perform temporally multiplexed operation of a hyperspectral analyzer and an alternate analyzer, using an active hyperpixel array imaging system, according to an embodiment.

FIG. 16 illustrates one exemplary adaptation of the method of FIG. 14 to perform spatially multiplexed operation of a hyperspectral analyzer and an alternate analyzer, using an active hyperpixel array imaging system, according to an embodiment.

FIG. 17 illustrates one exemplary active hyperpixel array imaging system including a separate spatial imaging system, according to an embodiment.

### DETAILED DESCRIPTION OF THE EMBODIMENTS

The present disclosure includes active hyperpixel array imaging systems and methods that overcome the problems associated with conventional hyperspectral imaging in the presence of relative movement between the object or area of interest and the hyperspectral imaging platform. The present systems utilize a “snapshot” type hyperspectral analyzer that provides two-dimensional images, each containing both spectral and spatial information. The density of spectral and spatial information is increased by incorporating an active element that functions as a dynamic slit or pinhole array. The active element may be reconfigured, at a high rate, to direct light from a certain portion of the scene under interrogation in a desired direction, such as towards the hyperspectral analyzer. For example, the active element may be used to track one or more objects of interest that is moving relative to the active hyperpixel array imaging system while capturing a series of images, each containing both spatial and spectral information. Since the active hyperpixel array imaging system adapts to the changing positions of the objects of interest, these images may be combined post-capture to yield high-density hyperspectral data cubes.

The active hyperpixel array imaging system may be configured to direct light only from a small region of interest, such as that associated with a moving object, towards the hyperspectral analyzer. As a result, the amount of data required to generate relevant hyperspectral information is reduced, and hyperspectral information may be collected more rapidly. Further, the active element allows for directing light from the scene under interrogation towards other system, for example a spatial imaging system for generation of tracking data to be used by the active hyperpixel array imaging system.

In another example of use, the active hyperpixel array imaging system tracks one or more objects of interest and captures images providing spectral information for each of the objects. In this case, the active hyperpixel array imaging system functions as a tracking spectrometer.

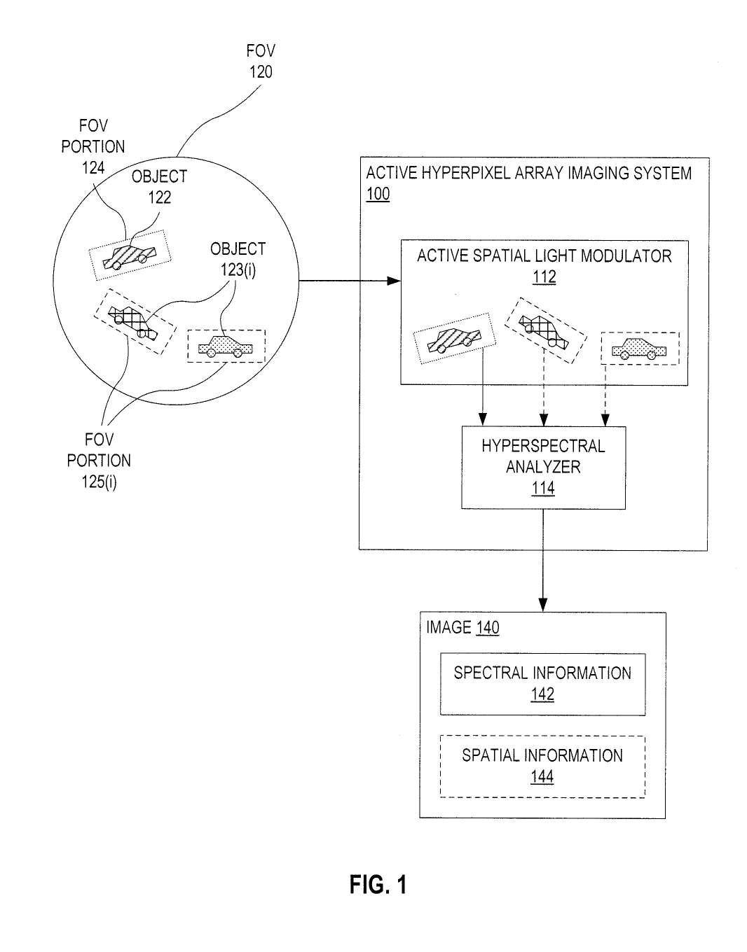

FIG. 1 illustrates an active hyperpixel array imaging system 100 including an active spatial light modulator 112 and a hyperspectral analyzer 114. Active hyperpixel array imaging system 100 has a field of view (FOV) 120. Active spatial light modulator 112 is dynamically configurable to direct light from a selected portion of FOV 120, an FOV portion 124, towards hyperspectral analyzer 114 for analysis of FOV portion 124. FOV portion 124 is for example a portion of FOV 120 associated with an object 122 of interest. Hyperspectral analyzer 114 generates an image 140 that includes spectral information 142 and, optionally, spatial information 144 for FOV portion 124. In one embodiment, image 140 is a two-dimensional hyperspectral image including both spectral information 142 and spatial information 144. In another embodiment, image 140 is a two-dimensional image including only spectral information 142 associated with a single spatial position.

The location, shape, and configuration of FOV portion 124 may be actively changed by dynamically configuring active spatial light modulator 112 to direct a desired portion of FOV 120 towards hyperspectral analyzer 114. For example, active spatial light modulator 112 may be dynamically configured to track object 122 as it moves within FOV 120 and capture a series of images 140 associated with object 122 while it is in motion. In another example, FOV selection 124 is scanned, by dynamically reconfiguring active spatial light modulator 112, across at least a portion of FOV 120. Hyperspectral information for an area or object of interest may be obtained rapidly from a series of images 140 captured while scanning a FOV portion 124 across the area or object of interest. In an embodiment, FOV portion 124 is a contiguous portion of FOV 120. In another embodiment, FOV portion 124 is composed of a plurality of disjointed portions of FOV 120, e.g., a plurality of parallel lines, an array of dots, or an array of unconnected portions of FOV 120. In yet another embodiment, FOV portion 124 is a single dot that is moved to track object 122 as it moves within FOV 120. In this case active hyperpixel array system 100 operates as a tracking spectrometer, generating spectral information 142 for object 122 during its movement.

In certain embodiment, active hyperpixel array imaging system 100 analyzes a plurality of FOV portions, FOV portion 124 and additional FOV portions 125(i) (only one labeled in FIG. 1), associated with a respectively plurality of objects of interest, object 122 and additional objects 123(i) (only one labeled in FIG. 1). Each object of interest, e.g., object 122 or 123(i), is associated with a FOV portion, e.g., FOV portion 124 or 125(i). Active spatial light modulator 112 directs light from all such FOV portions towards hyperspectral analyzer 114 to generate one or more images, e.g., image 140, including spectral information and, optionally, spatial information about each of the objects of interest. In one embodiment, active spatial light modulator 112 simultaneously directs light from the plurality of FOV portions towards hyperspectral analyzer 114 for generation of a two-dimensional image 140 that includes spatial and spectral information for plurality of objects of interest. In another embodiment, each object of interest, e.g., object 122, is analyzed in series. In this embodiment, active spatial light modulator 112 alternates between different FOV portions. A series of two-dimensional hyperspectral images, e.g., two-dimensional hyperspectral image 140, is generated by hyperspectral analyzer 114, where each individual hyperspectral image includes spatial and spectral information for a single FOV portion. In a further embodiment, each object of interest have spatial extent smaller than the spatial resolution of active hyperpixel array imaging system 100, and hyperspectral analyzer 114 generates spectral information, e.g., spectral information 142, for each of the objects.

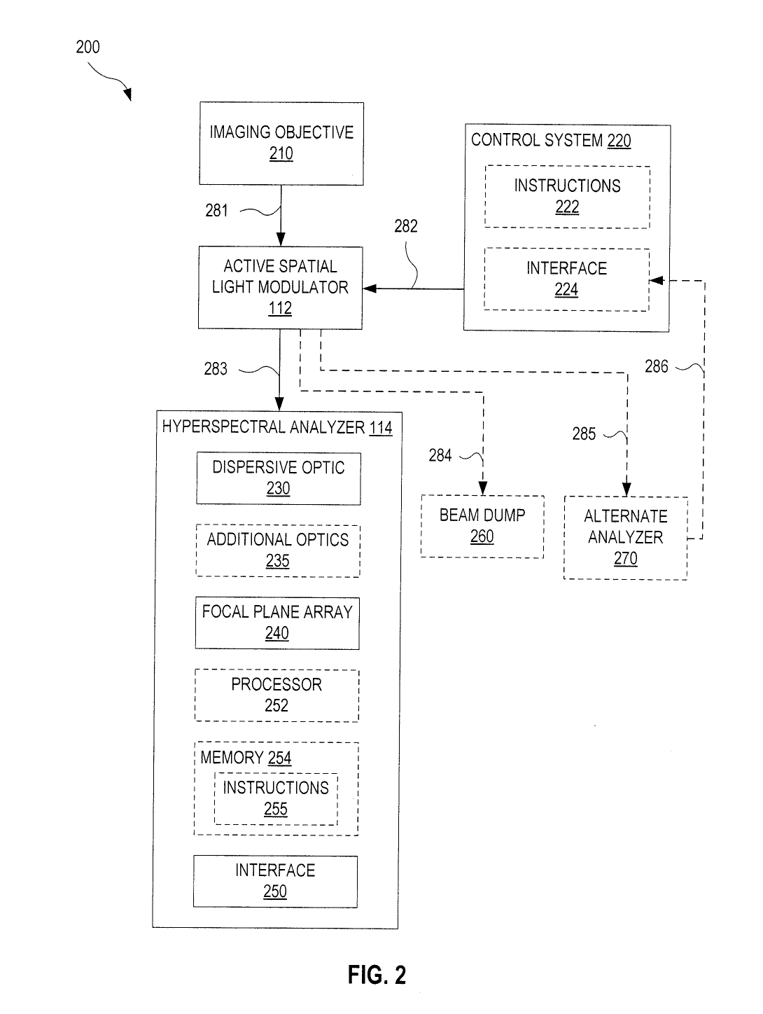

FIG. 2 illustrates an active hyperpixel array imaging system 200 including active spatial light modulator 112 and hyperspectral analyzer 114 of FIG. 1. Active hyperpixel array imaging system 200 further includes an imaging objective 210 for forming an intermediate image 281 of a field of view on active spatial light modulator 112. Active spatial light modulator is configurable by a control system 220, which communicates a control signal 282 to active spatial light modulator 112. In an embodiment, control signal 282 is an electronic signal. In another embodiment, control signal 282 is an optical signal. Based upon control signal 282, active spatial light modulator 112 directs light associated with a portion 283 of intermediate image 281 towards hyperspectral analyzer 114. Portion 283 is a portion of the field of view of active hyperpixel array imaging system 200, relayed to hyperspectral analyzer 114 through the intermediate image 281. For example, portion 283 is FOV portion 124 of FIG. 1.

Optionally, control system 220 includes machine-readable instructions 222, encoded in non-volatile memory, for generating control signal 282. For example, instructions 222 includes instructions for generating a series of control signals to dynamically control active spatial light modulator 112 to alternate between directing light from a FOV portion of interest towards hyperspectral analyzer 114 and towards alternate analyzer 270. Control system 220 may include an interface 224 for receiving instructions from a source external to control system 220. For example, instructions specifying the positions of one or more objects of interest may be received via interface 224. Based upon the received instructions, control signal 282 is adjusted to dynamically control active spatial light modulator 112.

Hyperspectral analyzer 114 includes a dispersive optic 230 for dispersing light into its spectral components. Dispersive optic 230 generates spectral information associated with portion 283. Hyperspectral analyzer 114 further includes a focal plane array 240 for capture of images, e.g., image 140 of FIG. 1, containing spectral information as generated by dispersive optic 230 and, optionally, spatial image data for portion 283. Focal plane array 240 is a two-dimensional pixelated light sensor. For capture of images 140 in the visible and near-infrared spectral range, focal plane array 240 may be a silicon based charge-coupled device (CCD) sensor or a silicon based complementary metal-oxide-semiconductor (CMOS) sensor. For capture of light in the infrared spectrum, including longer wavelengths than near-infrared, focal plane array may be a detector array with mercury-cadmium-telluride (MCT), Indium Antimonide (InSb), Indium Gallium Arsenide (InGaAs), or Vanadium Oxide (VOx) as the photosensitive material. Hyperspectral analyzer 114 includes an interface 250 for outputting captured images and, optionally, receiving control input such as gain and exposure time for focal plane array 240. In certain embodiments, hyperspectral analyzer 114 further includes a processor 252 and memory 254 for processing of an output from focal plane array 230. Such processing may include, e.g., converting raw output from focal plane array 240 to a desired image format according to instructions 255 located in memory 254, or analyzing multiple hyperspectral images captured by focal plane array 240 to form a hyperspectral data cube according to instructions 255. Processor 252, memory 254, and/or interface 250 may be located proximate focal plane array 240, on an external computer, or a combination thereof. Hyperspectral analyzer 114 may include additional optics 235 for manipulating the light as it propagates through hyperspectral analyzer 114. Additional optics includes, for example, imaging optics for forming an image on focal plane array 240.

Optionally, active spatial light modulator 112 directs light not associated with portion 283 of intermediate image 281, a non-selected portion 284, towards a beam dump 260. This prevents light from non-selected portion 284 from entering hyperspectral analyzer 114, where such light might otherwise increase the noise and/or background level of image 140. In an embodiment, non-selected portion 284 is all of intermediate image 281 not included in portion 283. In another embodiment, light from a portion 285 of intermediate image 281 not included in portion 283, and optionally not included in portion 284, is directed towards an alternate analyzer 270. Alternate analyzer 270 may be a spatial imaging system, an integrating spectral analyzer such as a multiband spatial heterodyne spectrometer, a hyperspectral analyzer, for example identical to hyperspectral analyzer 114, or a combination thereof. In certain embodiments, portion 285 defines a plurality of portions 285(i) and alternate analyzer 270 defines a plurality of alternate analyzer 270(i), wherein each portion 285(i) is directed towards a respective alternate analyzer 270(i). Data generated by alternate analyzer 270 may be communicated to control system 220 via interface 224 as alternate data 286.

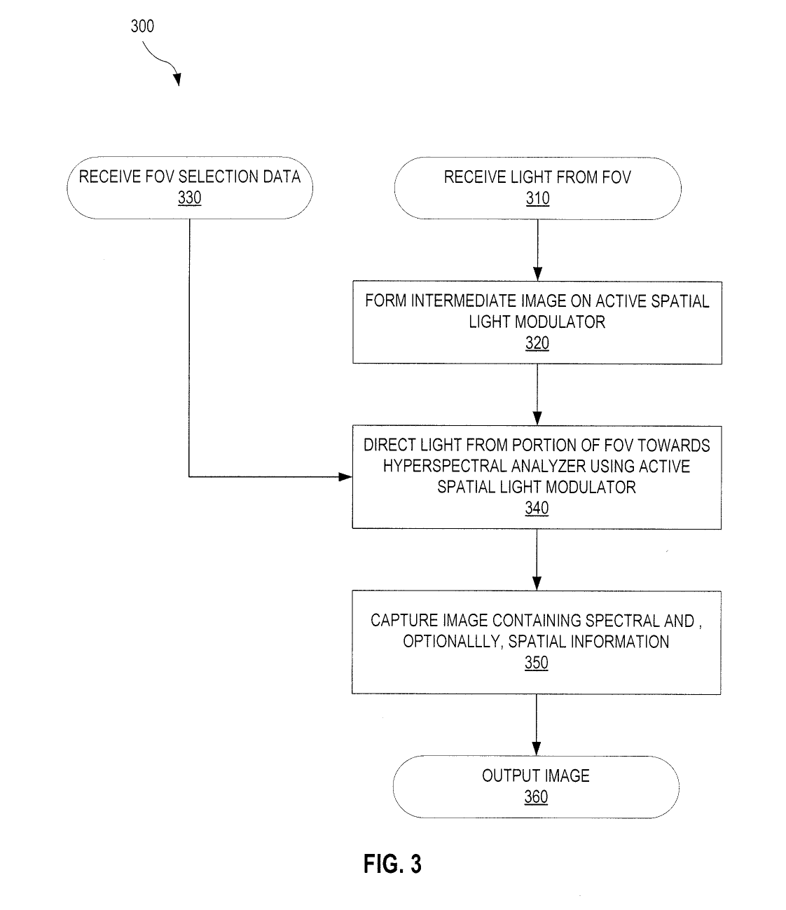

FIG. 3 illustrates a method 300 for generating an image using an active spatial light modulator and a hyperspectral analyzer. Method 300 may be performed by active hyperpixel array imaging system 200 of FIG. 2. In a step 310, light is received from a field of view, e.g., FOV 120 (FIG. 1). In a step 320, an intermediate image of the field of view is formed on an active spatial light modulator. In an example of step 320, imaging objective 210 (FIG. 2) forms intermediate image 281 (FIG. 2) on active spatial light modulator 112 (FIGS. 1 and 2). In a step 330, field of view selection data is received. Field of view selection data specifies a portion of the field of view to be directed towards a hyperspectral analyzer for spectral or hyperspectral analysis. Step 330 may be performed at any time before performing step 340, e.g., concurrently with, before, or after step 310 and/or step 320. Step 330 is performed, for example, by control system 220 (FIG. 2). In a step 340, an active spatial light modulator directs light from a portion of the field of view towards a hyperspectral analyzer. Since an intermediate image of the field of view is formed on the active spatial light modulator, light from a portion of the field of view is associated with a portion of the active spatial light modulator. Hence, light from a portion of the field of view may be directed in a desired direction, e.g., towards the hyperspectral analyzer, by directing light from the corresponding portion of the active spatial light modulator in the desired direction. For example, control system 220 (FIG. 2) communicates a control signal 282 (FIG. 2) to active spatial light modulator 112 (FIGS. 1 and 2), where the control signal 282 (FIG. 2) specifies a portion of active spatial light modulator 112 (FIGS. 1 and 2) that is to direct light towards hyperspectral analyzer 114 (FIGS. 1 and 2). In a step 350, an image associated with the selected portion of the field of view is captured. The image contains spectral and, optionally, spatial information. Hyperspectral analyzer 114 (FIGS. 1 and 2) may perform step 350 by using focal plane array 240 (FIG. 2) to capture, e.g., image 140 (FIGS. 1 and 2). In a step 360, the image generated in step 350 is outputted. Step 350 may be performed by interface 250 (FIG. 2).

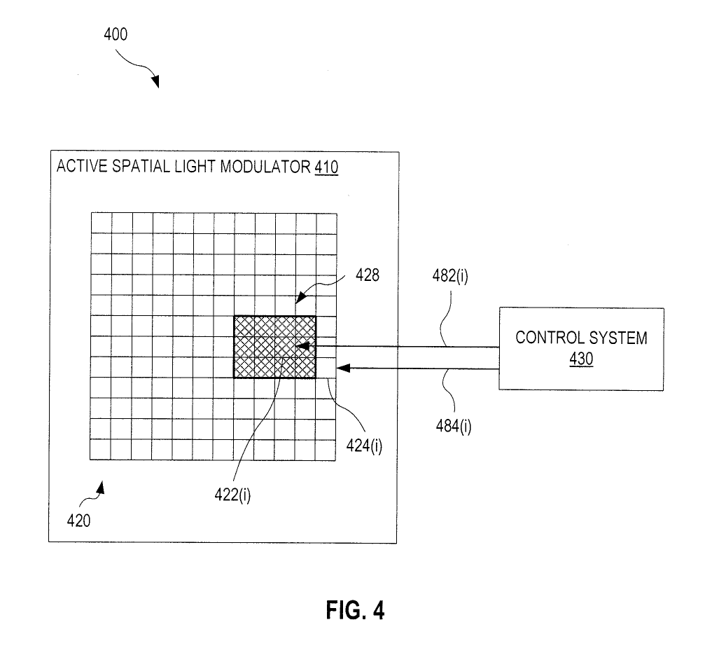

FIG. 4 illustrates an active system 400 for actively controlling the propagation of incident light. Active system 400 is used to, for example, direct light from a selected portion of a field of view towards a hyperspectral analyzer. Active system 400 is an embodiment of the subsystem of active hyperpixel array imaging system 200 (FIG. 2) composed of active spatial light modulator 112 (FIGS. 1 and 2), control system 220 (FIG. 2), and control signal 282 (FIG. 2), and may perform steps 330 and 340 of method 300 (FIG. 3). Active system 400 includes an active spatial light modulator 410, which is an embodiment of active spatial light modulator 112 of FIGS. 1 and 2. Active spatial light modulator 410 includes an array of discrete elements 420. Active system 400 further includes a control system 430, which is an embodiment of control system 220 (FIG. 2). Control system 430 controls the state of each element of array of discrete elements 420. Control system 430 may control each element of array of discrete elements 420 independently by communication of independent control signals to each element of array of discrete elements 420.

In an exemplary scenario 400, illustrated in FIG. 4, control system 430 communicates a control signal 482(i) to each discrete element 422(i) of array of discrete elements 420 located within a selection 428. Selection 428 represents a portion of an intermediate image of a field of view formed on active spatial light modulator 410. Selection 428 may be contiguous, as illustrated in FIG. 4, or consist of a plurality of disjointed sub-selections. The intermediate image may be intermediate image 281 (FIG. 2) formed by imaging objective 210 (FIG. 2). Control signal 482(i) sets the state of discrete elements 422(i) to direct light incident thereupon towards an analyzer such as hyperspectral analyzer 114 (FIGS. 1 and 2). Control system 430 communicates a control signal 484(i) to each discrete element 424(i) of array of discrete elements 420 located outside selection 428. Control signal 482(i) sets the state of discrete elements 422(i) to not direct light incident thereupon towards the analyzer.

In certain embodiments, active spatial light modulator 410 operates in reflection mode such that light incident upon array of discrete elements 420 may be directed towards a hyperspectral analyzer by reflection. In an embodiment exemplary hereof, array of discrete elements 420 is a mirror array, and the orientation of each mirror is independently configurable. In this case, control signals 482(i) and 484(i) may be electronic signals. In other embodiments, active spatial light modulator 410 operates in transmission mode, and the discrete elements of array of discrete elements 420 have configurable transmission.

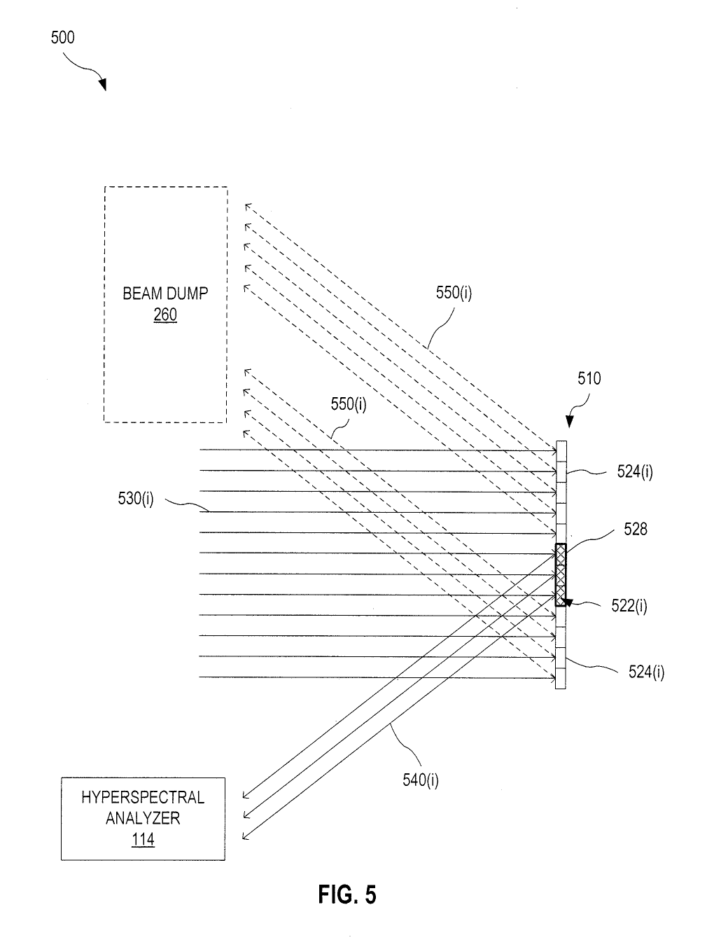

FIG. 5 illustrates an active hyperpixel array imaging system 500 including an active spatial light modulator 510 for directing light towards hyperspectral analyzer 114 (FIGS. 1 and 2). Active spatial light modulator 510 may be implemented in active system 400 (FIG. 4) as active spatial light modulator 410 and/or in system 200 (FIG. 2) as active spatial light modulator 210. Active spatial light modulator 510 operates in transmission mode. A discrete element of active spatial light modulator 510 may reflect light incident thereupon in a direction towards hyperspectral analyzer 114. In an embodiment, the discrete elements of active spatial light modulator 510 are always reflective but the direction of reflection is dynamically configurable.

In an exemplary scenario illustrated in FIG. 5, a selection 528 of discrete elements 522(i) are configured such that incident light 530(i), incident on discrete elements 522(i), is at least partially reflected towards hyperspectral analyzer as reflected light 540(i). Selection 528 may be contiguous, as illustrated in FIG. 4, or consist of a plurality of disjointed sub-selections. Optionally, incident light 530(i), incident on discrete elements 524(i) not included in selection 528 is reflected by discrete elements 524(i) towards a beam dump 260 (FIG. 2) as reflected light 550(i). This may be advantageous in embodiments where discrete elements 522(i) and 524(i) are always reflective. Directing reflected light 550(i) towards beam dump 260, prevents reflected light 550(i) from entering hyperspectral analyzer 114 through, e.g., reflection off discrete elements 524(i) combined with back reflection off optical surfaces upstream of active spatial light modulator 510. While FIG. 5 illustrates incident light 530(i) at normal angle of incidence onto active spatial light modulator 510, the incidence angle of incident light 530(i) onto active spatial light modulator 510 may be non-normal. Further, the propagation directions of incident light 530(i), reflected light 530(i), reflected light 540(i) need not be co-planar.

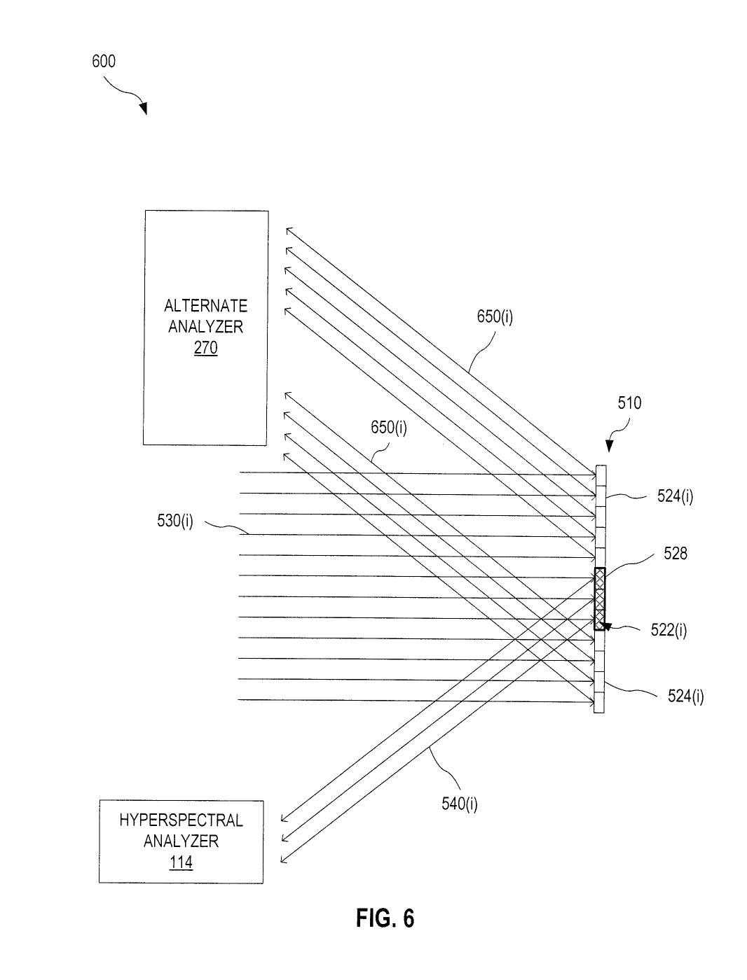

FIG. 6 illustrates an active hyperpixel array imaging system 600, which is identical to active hyperpixel array imaging system 500 except that alternate analyzer 270 replaces optional beam dump 260. In an exemplary scenario illustrated in FIG. 6, incident light 530(i), incident on discrete elements 524(i) not included in selection 528, is reflected as reflected light 650(i) in a direction towards alternate analyzer 270. In a related scenario, not illustrated in FIG. 6, some but not all of discrete elements 524(i) reflect light in the direction towards alternate analyzer 270.

As discussed for active hyperpixel array imaging system 200 (FIG. 2), active hyperpixel array imaging system 600 may be extended to include any number of alternate analyzers 270(i), and optionally a beam dump, by placing these elements in locations corresponding to different directions of reflection off of the discrete elements of active spatial light modulator 510.

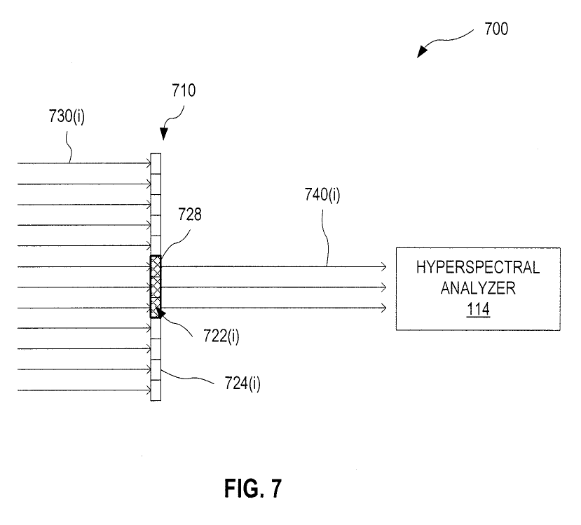

FIG. 7 illustrates an active hyperpixel array imaging system 700 including an active spatial light modulator 710 that operates in transmission mode. Active spatial light modulator 710 may be implemented inactive system 400 (FIG. 4) as active spatial light modulator 410 and/or in system 200 (FIG. 2) as active spatial light modulator 210. A discrete element of active spatial light modulator 710 may at least partially transmit light incident thereupon, thereby allowing the transmitted light to propagate towards hyperspectral analyzer 114 (FIGS. 1 and 2).

In an exemplary scenario illustrated in FIG. 7, discrete elements 722(i) of active spatial light modulator 710 located within a selection 728 are configured to be transmissive. Incident light 730(i), incident on discrete elements 722(i), is at least partially transmitted by discrete elements 722(i) and propagates towards hyperspectral analyzer 114 as transmitted light 740(i). Discrete elements 724(i) not included in selection 728 are configured to not transmit light 730(i) incident thereon. In an embodiment, discrete elements 724(i) absorb incident light 730(i). In another embodiment, discrete elements 724(i) reflect incident light 730(i). In yet another embodiment, discrete elements 724(i) block incident light 730(i) by a combination of absorption and reflection thereof.

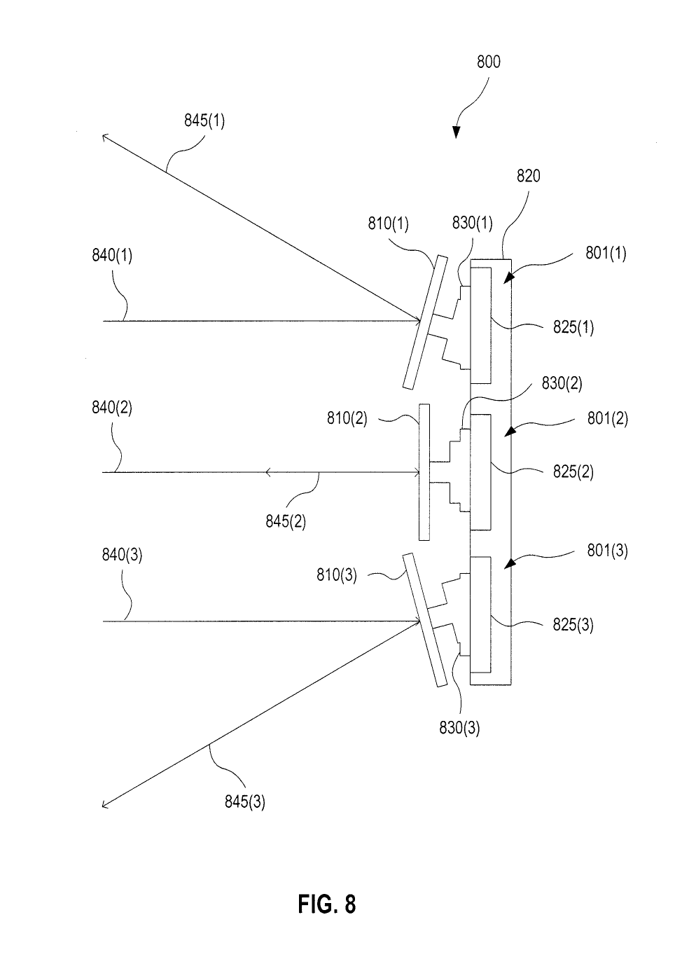

FIG. 8 illustrates an active spatial light modulator 800, which is an embodiment of active spatial light modulator 510 (FIGS. 5 and 6). Active spatial light modulator 800 is a digital mirror device. Active spatial light modulator 800 includes discrete elements 801(i) mounted on a common substrate 820 (three exemplary discrete elements 801(1), 801(2), and 801(3) are shown in FIG. 8). Each discrete element 801(i) includes a reflector 810(i), an actuation mechanism 830(i), and electronic circuitry 825(i). Reflector 810(i) is mounted onto actuation mechanism 830(i). Electronic circuitry 825(i) controls actuation mechanism 830(i), thereby controlling the orientation of reflector 810(i). Light incident on reflector 810(i) is at least partially reflected by reflector 810(i) in a direction defined by the angle of incidence of the incident light and the orientation of reflector 810(i). Electronic circuitry 825(i) may be in communication with an external control system (not shown in FIG. 8) and receive electronic control signals therefrom. For example, control system 430 (FIG. 4) may control the orientation of each reflector 810(i) by communicating electronic control signals to each respective electronic circuitry 825(i). In certain embodiments, discrete elements 801(i) are microelectromechanical systems (MEMS).

For illustration, FIG. 8 shows reflectors 801(1), 801(2), and 801(3) with three different exemplary orientations. Three exemplary incident light rays 840(1), 840(2), and 840(3) incident on respective reflectors 801(1), 801(2), and 801(3) propagate in a direction orthogonal to active spatial light modulator 800. Incident light ray 840(1) is at least partially reflected by reflector 810(1) to generate a reflected light ray 845(1) propagating in an upwards direction. Incident light ray 840(2) is at least partially reflected by reflector 810(2) to generate a reflected light ray 845(2) counter-propagating to incident light ray 840(2). Incident light ray 840(3) is at least partially reflected by reflector 810(3) to generate a reflected light ray 845(3) propagating downwards. In one exemplary scenario, reflected rays 845(i) propagating downwards are directed towards a hyperspectral analyzer, e.g., hyperspectral analyzer 114 as illustrated in FIGS. 5 and 6. Upwards propagating reflected rays 845(i) are directed towards a beam dump, e.g., beam dump 260 as illustrated in FIG. 5, or towards an alternate analyzer, for example alternate analyzer 270 as illustrated in FIG. 6. The incidence angle of light incident on active spatial light modulator 800 need not be normal (as shown in FIG. 8). In certain embodiments, incident light rays 840(1), 840(2), and 840(3) propagate at an oblique angle relative to active spatial light modulator 800.

In an embodiment, actuation mechanism 830(i) provides one-dimensional angle adjustment of reflector 810(i), for example by pivoting about a single axis. The orientation of reflector 810(i) is defined by a single angle and an associated angle range, where the angle range is determined by the range of motion of actuation mechanism 830(i) together with spatial constraints associated with reflector 810(i), actuation mechanism 830(i), electronic circuitry 825(i), and substrate 820. In another embodiment, actuation mechanism 830(i) provides two-dimensional angle adjustment of reflector 810(i), for example by independently pivoting about two axes. In this case, the range of orientations of reflector 810(i) is defined by a solid angle and an associated solid angle range. Two orthogonal angles, each having an angular range, define the solid angle. The two orthogonal angles may be associated with different angular ranges.

Active spatial light modulator 800 allows for directing incident light towards a plurality of analyzers and/or beam dumps. The maximum number of analyzers and/or beam dumps is determined by the angular ranges of reflectors 810(i) and spatial constraints associated with the analyzers and/or beam dumps and the system as a whole.

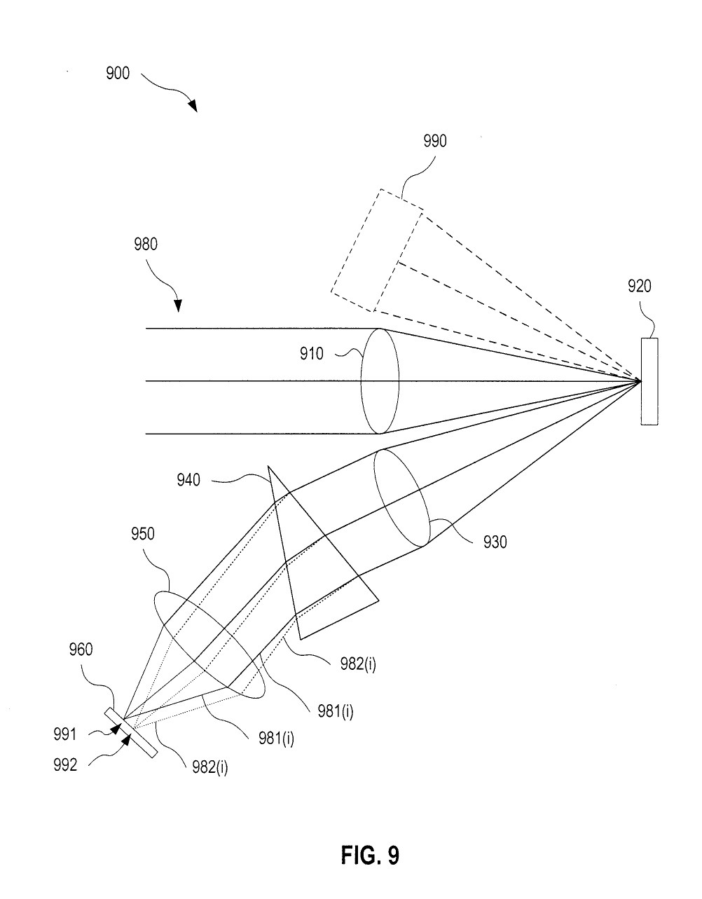

FIG. 9 illustrates an active hyperpixel array imaging system 900. Active hyperpixel array imaging system 900 is one exemplary embodiment of active hyperpixel array imaging system 200. Active hyperpixel array imaging system 900 includes an imaging objective 910, an active spatial light modulator 920, a collimating objective 930, a prism 940, an imaging objective 950, and a focal plane array 960. Imaging objective 910 is an embodiment of imaging objective 210 (FIG. 2). Active spatial light modulator 920 is an embodiment of active spatial light modulator 112 (FIGS. 1 and 2) and is, for example, active spatial light modulator 510 (FIGS. 5 and 6) or active spatial light modulator 800 (FIG. 8). The subsystem composed of collimating objective 930, prism 940, imaging objective 950, and focal plane array 960 is an embodiment of hyperspectral analyzer 114 (FIGS. 1 and 2); interface 250, optional processor 252, and optional memory 254 are not shown in FIG. 9. Specifically, prism 940 is an embodiment of dispersive optic 230 (FIG. 2), focal plane array 960 is an embodiment of focal plane array 240 (FIG. 2), and interface 970 is an embodiment of interface 250 (FIG. 2).

Optionally, active hyperpixel array imaging system 900 further includes an alternate system 990. In an embodiment, alternate system 990 is a beam dump, for example beam dump 260 (FIG. 2). In another embodiment, alternate system 990 is an alternate analyzer, e.g., alternate analyzer 270 (FIG. 2). In certain embodiments, alternate analyzer 990 is a spatial imaging system sensitive to light in, e.g., the visible spectrum, the infrared spectrum, portions thereof, or combinations thereof.

One or more of imaging objective 910, collimating objective 930, and imaging objective 950 may be a composite optical system composed of multiple optical elements including lenses, mirrors, apertures, and filters. In an embodiment, one or more of imaging objective 910, collimating objective 930, and imaging objective 950 is a reflective objective composed of mirrors. Prism 940 may be a composite dispersive optic.

Active hyperpixel array imaging system 900 receives light, illustrated as incoming rays 980, initially collimated and propagating parallel to the optical axis of imaging objective 910. In the following, rays 980 are traced through the system. Imaging objective 910 images rays 980 onto a point on active spatial light modulator 920, thereby forming an intermediate image. Active spatial light modulator 920 redirects rays 980 towards collimating objective 930. Between active spatial light modulator 920 and collimating objective 930, rays 980 are diverging. Collimating objective 930 re-collimates rays 980. Prism 940 disperses rays 980 into their spectral components. FIG. 9 illustrates two spectral components, where prism 940 splits rays 980 into spectral components 981 and 982 of different wavelengths. Rays of each spectral component of ray 980, e.g., spectral components 981 or 982, are collimated subsequent to passing through prism 940. However, the angle of propagation is a function of the wavelength of the spectral component. Imaging objective 950 images rays of each spectral component of ray 980 onto a different portion of focal plane array 960, e.g, spectral components 981 and 982 are imaged onto respective portions 991 and 992 of focal plane array 960.

Prism 940 disperses rays 980 in one dimension (in the plane of FIG. 9) and leaves the propagation of rays 980 unaffected in the orthogonal dimension. Therefore, spectral information of the intermediate image formed on active spatial light modulator 920 is displayed in one dimension (in the plane of FIG. 9) of the two-dimensional image formed on focal plane array 960. Spatial information of the intermediate image formed on active spatial light modulator 920, in the dimension orthogonal to the plane of FIG. 9, is retained and displayed in the image in the dimension orthogonal to the plane of FIG. 9.

In contrast to the optical axis of imaging objective 910, the optical axis of collimating objective 930 is not orthogonal to the light receiving surface of active spatial light modulator 920. Therefore, light reflected by active spatial light modulator 920 represents a tilted image of the intermediate image formed on active spatial light modulator 920. In certain embodiments, the subsystem composed of collimating objective 930, prism 940, imaging objective 950, and focal plane array 960 is adapted to compensate for this tilt, for example by tilting focal plane array 960 accordingly. Alternatively, one or more of collimating objective 930, prism 940, and imaging objective 950 correct for the tilt.

In an embodiment, active spatial light modulator 920 is a MEMS based digital mirror device, wherein individual mirrors are reconfigurable at rates in excess of 10 kilohertz. The mirrors may have a one-dimensional angular movement range in the range of ±10° to ±30°.

In certain embodiments, the angular movement range of the mirrors of active spatial light modulator 920 determines the maximum possible collection efficiency and field of view angle of active hyperpixel array imaging system 900. The space occupied by imaging objective 910 and the associated solid angle of light propagating between imaging objective 910 and active spatial light modulator 920 must not interfere with collimating objective 930 and the associated solid angle of light propagating between active spatial light modulator 920 and collimating objective 930. Hence, the angle between the two solid angles of light respectively incident on and reflected from active spatial light modulator 920 may become the limiting factor for the collection efficiency and field of view angle of active hyperpixel array imaging system 900. In an embodiment, the collection efficiency, defined by the f-number, is in the range f/2-f/3, and the field of view angle is in the range 10°-30°.

In a particular embodiment, the propagation direction of rays 980 incident on imaging objective 910, and the optical axis of imaging objective 910, are orthogonal to the reflective surface of active spatial light modulator 920. In an alternative embodiment, the propagation direction of rays 980 and the optical axis of imaging objective 910 are at an oblique angle to the reflective surface of active spatial light modulator 920. This allows for greater separation between the solid angles associated with light incident on and reflected from active spatial light modulator 920 and, accordingly, greater collection efficiency.

In one embodiment, focal plane array 960 is sensitive to light in the near-infrared and short-wave-infrared spectral ranges, i.e., 0.7-3 micron. Focal plane array 960 is, for example, an InSb array or an MCT array with a pixel resolution of, e.g., 512×475 pixels, 640×480 pixels, or 825×480 pixels. The pitch between pixels is, for example, in the range of 10-50 micron.

A number of factors determine the maximum rate of generation of spectral data or hyperspectral data cubes by active hyperpixel array imaging system 900. These factors include (a) the reconfiguration rate of elements of active spatial light modulator 920, (b) the frame rate, sensitivity, and noise properties of focal plane array 960, (c) if applicable, the desired spatial resolution of the hyperspectral data cube, (d) the desired spectral resolution and bandwidth, (e) the brightness of the object or scene to be analyzed, (f) the light transmission efficiency of the train of optical components in active hyperpixel array imaging system 900, (g) the desired signal-to-noise ratio, and (h) the size of the field of view to be analyzed. Various trade-offs exist between these factors. For example, for a given hyperspectral cube generation rate, spectral resolution may be traded for spectral bandwidth or spatial resolution; and spectral resolution/bandwidth and spatial resolution may be traded for signal-to-noise of the hyperspectral data cube or the size of the field of view to be analyzed. In certain embodiments, data cubes with a spatial resolution of 640×480 pixels, a spectral resolution of 10 nanometers, and a spectral bandwidth corresponding to the wavelength range 0.7-2.35 micron are generated at rates in the range of 1-50 Hertz for a field of view angle in the range 10°-30° with a collection efficiency corresponding to an f-number in the range f/2.4-f/2.8.

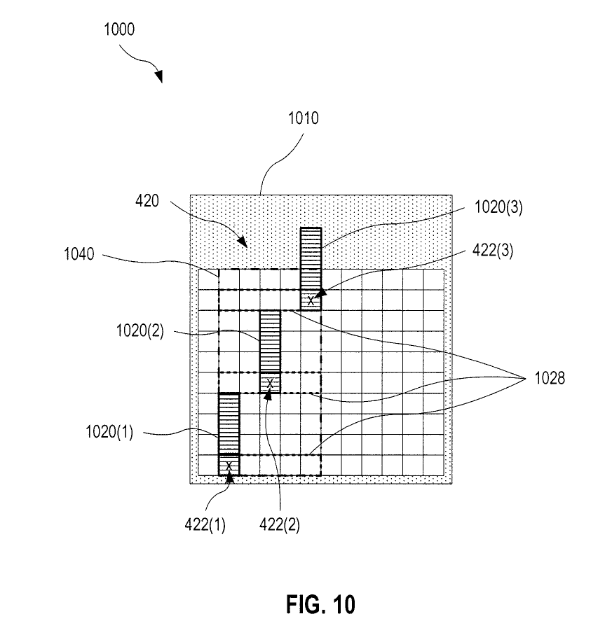

FIG. 10 is a diagram 1000 illustrating the correspondence between the array of discrete elements 420 of active spatial light modulator 410 and an image generated by hyperspectral analyzer 114 (FIGS. 1 and 2). This correspondence applies, for example, to active hyperpixel array imaging system 900 of FIG. 9 and active hyperpixel array imaging system 200 of FIG. 2. In the following, diagram 1000 is discussed in the context of system 200 (FIG. 2) with active spatial light modulator 410 (FIG. 4) implemented as active spatial light modulator 112 (FIG. 2). Diagram 1000 illustrates a scenario where the active spatial light modulator is operated as a dynamic slit array.

Array of discrete elements 420 is shown overlaid on an image 1010 generated by hyperspectral analyzer 114 (FIGS. 1 and 2). Three exemplary discrete elements 422(1), 422(2) and 422(3), of array of discrete elements 420, correspond to respective spectral streaks 1020(1), 1020(2), and 1020(3) in image 1010. Each pair of corresponding discrete element and spectral streak, e.g., discrete element 422(1) and spectral streak 1020(1) constitute a hyperpixel. Hence, image 1010 includes an array of hyperpixels. Dispersive optic 230 introduce spectral streaks 1020(1), 1020(2), and 1020(3) (FIG. 2). Each of spectral streaks 1020(1), 1020(2), and 1020(3) displays, in the vertical dimension, a spectral decomposition of the portion of the intermediate image 281 (FIG. 2) associated with discrete elements 422(1), 422(2) and 422(3), respectively. The horizontal dimension of image 1010 retains the spatial information of intermediate image 281 (FIG. 2). Accordingly, each horizontal line in image 1010 is a spatial image of a certain spectral component. Spectral decompositions of a spatial feature are displayed along vertical lines in image 1010. In an embodiment, the focal plane array used to generate image 1010 has an aspect ratio different from that of array of discrete elements 420 such that complete spectral streaks may be recorded for each discrete element of array of discrete elements 420.

The pixel resolution of the focal plane array used to capture image 1010 is independent of the resolution of array of discrete elements 420. In one embodiment, the pixel resolution of the focal plane array is matched the underlying resolution of images formed thereon, for example by setting the inter-pixel pitch similar to the diameter of the blur spot characteristic of the image. This may be achieved by adjusting, e.g., the magnification of the optical system forming the image, the inter-pixel pitch of the focal plane array, or a combination thereof. In certain embodiments, the resolution of array of discrete elements 420 is similar to the underlying resolution of the intermediate image formed thereon. The pitch between discrete elements is, for example, similar to the diameter of the blur spot characteristic of the intermediate image. In another embodiment, the resolution of array of discrete elements 420 is higher than the underlying resolution of the intermediate image formed thereon. In this case, the pitch between discrete elements is, for example, less than the radius of the blur spot characteristic of the intermediate image.

The spectral range spanned by the light to be analyzed and the degree of dispersion introduced by dispersive optic 230 determine the possible length of spectral streaks 1020(1), 1020(2), and 1020(3). In order to avoid overlap between spectral decompositions associated with different discrete elements of array of discrete elements 420, the selection of discrete elements that directs light towards hyperspectral analyzer 1010 (FIGS. 1 and 2) is set such that different spectral streaks of image 1010 have minimal or no overlap. Selection 1028 indicates an exemplary selection resulting in no overlapping spectral streaks. Selection 1028 consists of three rows of discrete elements, equivalent to a slit array with three slits.

In an alternative scenario, selection 1028 may include only a single row of discrete elements, in which case an active hyperpixel array imaging system, e.g., active hyperpixel array imaging system 900 (FIG. 9) may be operated as an active slit spectrometer. In a similar scenario, selection 1028 may include only an array of non-contacting groups of discrete elements. This is equivalent to a pinhole array. The size of the dots defining the pinholes may be adjusted as desired by changing the number of discrete elements in each group of discrete elements. In this case, an active hyperpixel array imaging system, e.g., active hyperpixel array imaging system 900 (FIG. 9) may be operated as an active pinhole array spectrometer.

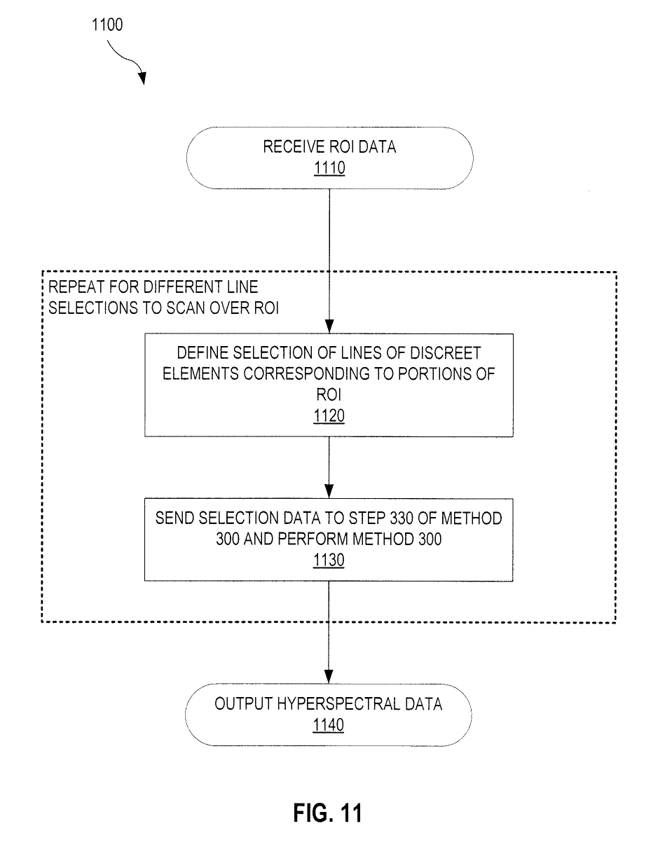

FIG. 11 illustrates a method 1100 for generating hyperspectral data using an active hyperpixel array imaging system with active spatial light modulator 410 (FIG. 4) implemented as active spatial light modulator 112 (FIGS. 1 and 2). Method 1100 may be performed by active hyperpixel array imaging system 200 of FIG. 2. FIG. 11 is best viewed together with FIG. 10. In a step 1110, the definition for a region of interest (ROI) is received. The ROI is a field of view, or portion thereof, of a hyperpixel array imaging system, e.g., FOV portion 124 of FIG. 1 or an ROI 1040 of array of discrete elements 420 as illustrated in FIG. 10. Step 1110 is, for example, performed by control system 220 (FIG. 2) through interface 224 (FIG. 2). In a step 1120, a selection of one or more lines of discrete elements of array of discrete elements 420 is defined. For example, step 1120 is performed by control system 220 (FIG. 2), which defines selection 1028 (FIG. 10) according to instructions 222 (FIG. 2). In a step 1130, the selection generated is sent to step 330 of method 300, and method 300 is performed, as discussed in connection with FIG. 3. This produces a two-dimensional hyperspectral image for selection 1028 (FIG. 10). Steps 1120 and 1130 are repeated for different selections 1028 to cover all of the ROI received in step 1110. In one example, the rows defining selection 1028 (FIG. 10) are dynamically shifted in the vertical dimension, by using control system 220 (FIG. 2), to perform a scan over ROI 1040 (FIG. 10). In a step 1140, hyperspectral data is outputted. Step 1140 may be performed by interface 250 (FIG. 2).

The hyperspectral data outputted in step 1140 may be in the form of a series of two-dimensional hyperspectral images as captured for each instance of selection 1028. In certain embodiments, the hyperspectral images compiled during the scan are combined to form a dense hyperspectral data cube for the ROI. For example, processor 255 (FIG. 2) generates the hyperspectral data cube according to instructions 255 (FIG. 2). In an embodiment, array of discrete elements 420 is a MEMS mirror array where the mirror orientation, i.e., the state of a discrete element, is reconfigurable at rates in the range 1-100 kilohertz, and a dense hyperspectral data cube is rapidly generated.

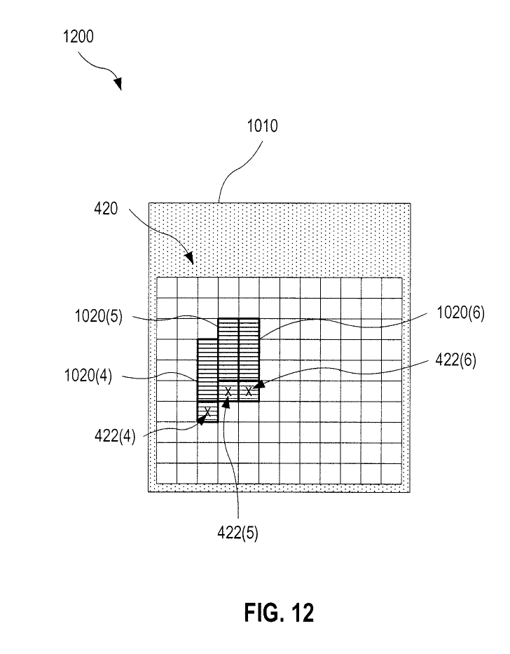

FIG. 12 is a diagram 1200 illustrating the correspondence between the array of discrete elements 420 of active spatial light modulator 410 and an image generated by hyperspectral analyzer 114 (FIGS. 1 and 2). This correspondence applies, for example, to active hyperpixel array imaging system 900 of FIG. 9 and active hyperpixel array imaging system 200 of FIG. 2. In the following, diagram 1200 is discussed in the context of system 200 (FIG. 2) with active spatial light modulator 410 (FIG. 4) implemented as active spatial light modulator 112 (FIG. 2). Diagram 1200 is equivalent to diagram 1000 of FIG. 10, except that diagram 1200 illustrates a scenario where the active spatial light modulator is operated as a dynamic pinhole for tracking of an object as it moves within the field of view of the hyperpixel array imaging system.

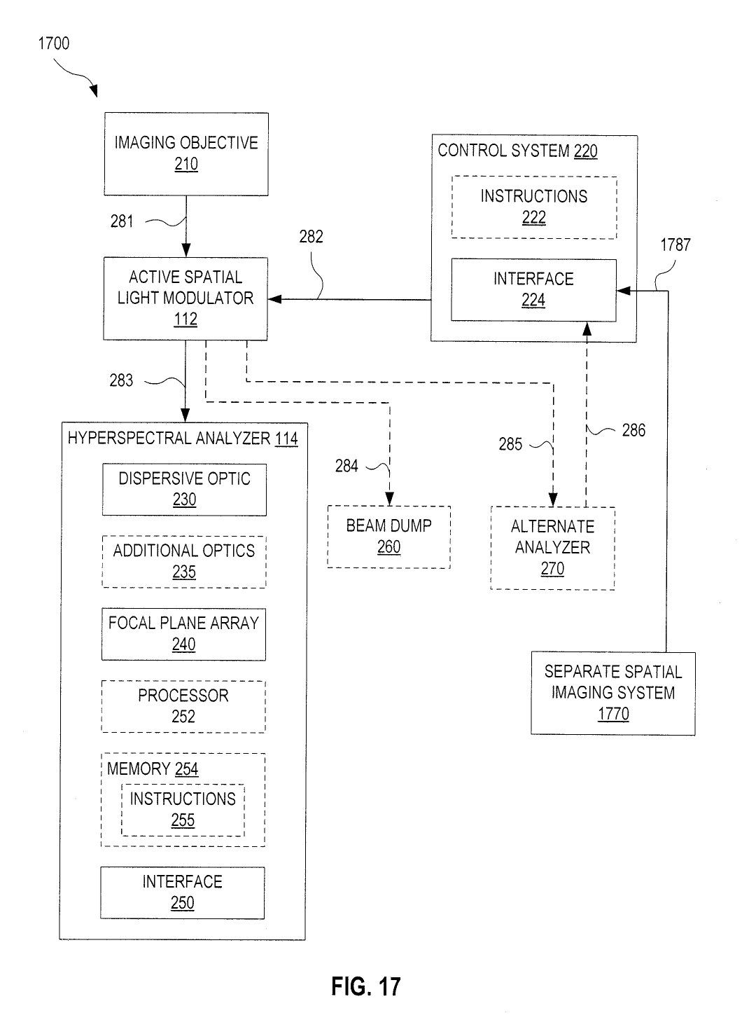

As an object of interest moves within the field of view, array of discrete elements is dynamically reconfigured to track the position of the object. In an embodiment, tracking information for the position of the object of interest is obtained by interface 224 of control system 220 from alternate analyzer 270 as alternate data 286, where alternate analyzer 270 is, e.g., a spatial imaging system. In another embodiment, interface 224 receives such tracking information from a different source, for example a separate spatial imaging system as discussed below in connection with FIG. 17. Control system 220 controls active spatial light modulator 112, according to the tracking information, by communicating control signals 282 to active spatial light modulator 112. Three discrete elements 422(4), 422(5), and 422(6), of array of discrete elements 420, correspond to an exemplary trajectory of the object of interest. Discrete elements 422(4), 422(5), and 422(6) correspond to respective spectral streaks 1020(4), 1020(5), and 1020(6) in image 1010. Each pair of discrete element and corresponding spectral streak, e.g., discrete element 422(4) and spectral streak 1020(4) constitute a hyperpixel. While the object of interest moves through positions corresponding to discrete elements 422(4), 422(5), and 422(6), spectral streaks 1020(4), 1020(5), and 1020(6) are captured in a sequence of three images 1010, each including a hyperpixel providing spectral information for the object of interest. In an embodiment, not shown in FIG. 12, each position of the object along its trajectory is analyzed by a group of discrete elements rather than a single discrete element. For example, each of discrete elements 422(4), 422(5), and 422(6) may be replaced by corresponding groups of discrete elements including, e.g., four or nine discreet elements. In general terms, array of discrete elements is dynamically configured to scan a dot of one or more discrete elements to track the position of the object of interest.

The scenario illustrated in FIG. 12 allows for continuously collecting spectral information about the object of interest at a high rate. In low-light situations, the spectral streaks, e.g., spectral streaks 1020(4), 1020(5), and 1020(6) may be integrated to collect spectral information of a desired signal-to-noise ratio without motion-induced data degradation. For comparison, conventional hyperspectral imaging systems, analyzing the full field of view, need to account for object movement by shifting the full field of view of the system and integrating full images. This results in a very high data load.

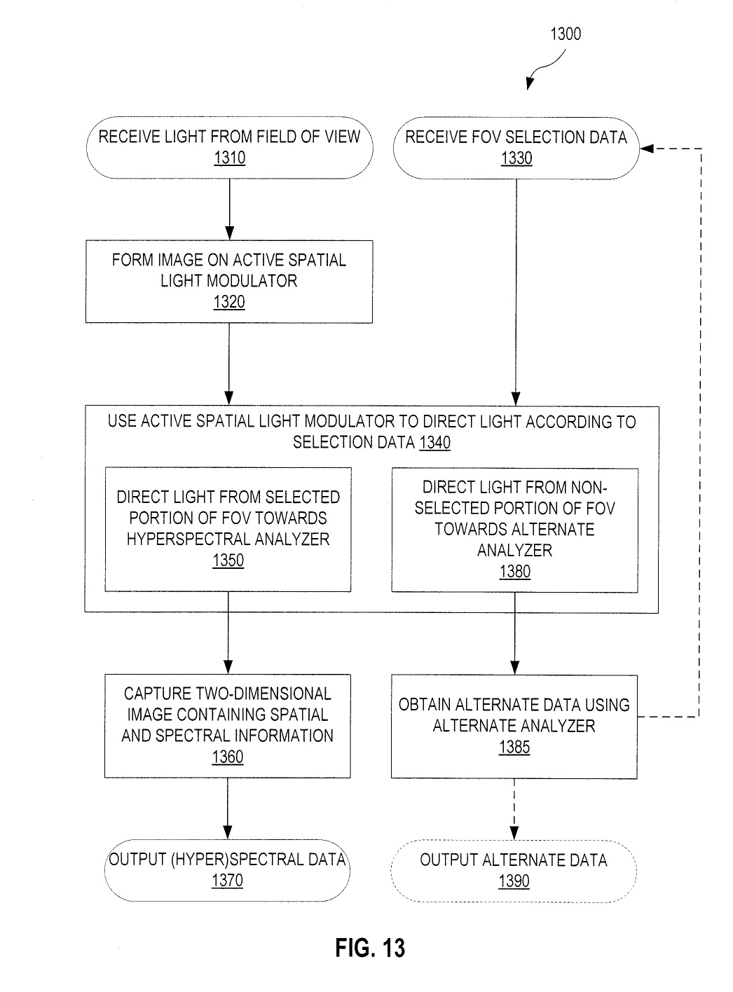

FIG. 13 illustrates a method 1300 for generating both spectral, or hyperspectral, data and alternate data using an active hyperpixel array imaging system with a hyperspectral analyzer and an alternate analyzer. Method 1300 may be performed by active hyperpixel array imaging system 200 of FIG. 2 with optional alternate analyzer 270 included, or by active hyperpixel array imaging system 900 (FIG. 9) with optional alternate system 980 included in the form of an alternate analyzer. In a step 1310, light is received from a field of view. For example, light from a field of view may be received by imaging objective 210 (FIG. 2). In a step 1320, an intermediate image of the field of view is formed on an active spatial light modulator. Step 1320 is, for example, performed by imaging objective 210 (FIG. 2) by forming intermediate image 281 (FIG. 2) on active spatial light analyzer 112 (FIGS. 1 and 2). In a step 1330, which may be performed in parallel or series with steps 1310 and 1320, selection data defining at least of portion of the field of view is received. For example, interface 224 (FIG. 2) performs step 1330. In a step 1340, the active spatial light modulator, on which the intermediate image is formed, directs light towards a hyperspectral analyzer according to the selection data received in step 1330. Since an intermediate image of the field of view is formed on the active spatial light modulator, light from the portion of the field of view specified in step 1330 is associated with a portion of the active spatial light modulator. Hence, light from a portion of the field of view may be directed in a desired direction by directing light from the corresponding portion of the active spatial light modulator in the desired direction. Step 1340 includes two steps 1350 and 1380 that may be performed concurrently to achieve parallel operation of the hyperspectral analyzer and the alternate analyzer.

In step 1350, the active spatial light modulator directs light towards the hyperspectral analyzer according to the selection data received in step 1330. Step 1350 is, for example, performed by active spatial light modulator 112 (FIGS. 1 and 2), which directs light from the selection towards hyperspectral analyzer 114 (FIGS. 1 and 2) according to control signal 282 (FIG. 2) received from control system 220 (FIG. 2). In a step 1360, the hyperspectral analyzer captures an image. The image contains spectral and, optionally, spatial information as discussed in connection with FIG. 10. Step 1360 may be performed by hyperspectral analyzer 114 (FIGS. 1 and 2) using focal plane array 240 (FIG. 2). In a step 1370, the spectral or hyperspectral data is outputted, for example by interface 250 (FIG. 2). In an embodiment, method 1300 is combined with method 1100, i.e., by repeatedly performing steps 1350 and 1360 to scan over the selection received in step 1230.

In step 1380, light received from the field of view in step 1310 and not associated with the selection received in step 1330 is directed towards an alternate analyzer. Step 1380 is, for example, performed by active spatial light modulator 112 (FIGS. 1 and 2), which directs light not associated with the selection received in step 1330 towards alternate analyzer 270 (FIG. 2) according to control signal 282 (FIG. 2) received from control system 220 (FIG. 2). Instructions 222 may include instructions for determining the selection of light to be directed towards alternate analyzer 270 based on the selection data received in step 1330. In a step 1385, alternate data is obtained using the alternate analyzer, e.g., alternate analyzer 270 (FIG. 2). Optionally, in a step 1290, the alternate data is outputted, e.g., by alternate analyzer 270.

Method 1300 may be repeated for a plurality of different FOV selection data. For example, a plurality of objects of interest may be associated with a respective plurality of FOV selection data to provide spectral or hyperspectral data for each of the objects of interest. Alternatively, FOV selection data may include a plurality of FOV portions associated with a respective plurality of objects of interest.

In certain embodiments, the alternate data obtained in step 1385 includes data that defines a portion of the field of view of particular interest. This selection data is sent to step 1330 and method 1300 is performed with this input. In such embodiments, the active hyperpixel array imaging system is actively controlled based on information obtained from the alternate analyzer. The alternate analyzer, e.g., alternate analyzer 270 of FIG. 2, may be a spatial imaging system providing images that determines the positions of one or more objects of interest within the field of view, e.g., a tracking system. Spatial data generated by such a spatial imaging system may be communicated to control system 220 via interface 224 as alternate data 286. The spatial data is, for example, tracking data for an object of interest, as discussed in connection with FIG. 12. In an example, the selected FOV portion coincides with an object of interest. As the object of interest moves within the FOV, it may leave the selected FOV portion and appear in a spatial image, captured by the spatial imaging system, of the non-selected FOV portion. Upon detection of the object in the spatial image, the position of the object is recalculated and the FOV selection data, defining the selected FOV portion, updated to track the position of the object of interest.

Control system 220 may use such tracking data to control active spatial light modulator 112, according to instructions 222. For example, active spatial light modulator 112 may direct light from a FOV portion associated with the one or more objects of interest towards hyperspectral analyzer 114, as discussed in connection with FIG. 1.

This form of use of an alternate analyzer allows for continuously tracking one or more objects moving within the field of view of the hyperpixel array imaging system, and collecting spectral or hyperspectral data while the objects are moving. The objects may be moving at different speeds and in different directions. In comparison, a hyperspectral imaging method, not utilizing tracking, is forced to direct light from all of the field of view towards a hyperspectral analyzer. The present method, utilizing tracking, reduces the data capacity requirements and/or increases the speed with which relevant spectral or hyperspectral data is generated.

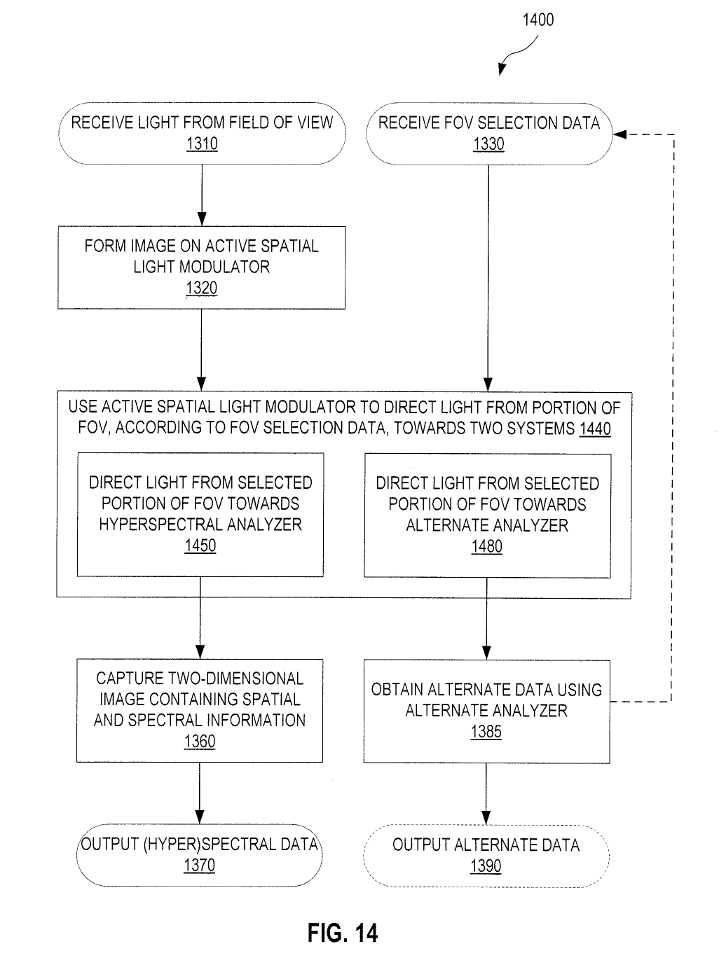

FIG. 14 illustrates a method 1400 for generating both spectral or hyperspectral data and alternate data using an active hyperpixel array imaging system with a hyperspectral analyzer and an alternate analyzer. Method 1400 may be performed by active hyperpixel array imaging system 200 of FIG. 2 with optional alternate analyzer 270 included, or by active hyperpixel array imaging system 900 (FIG. 9) with optional alternate system 980 included in the form of an alternate analyzer. Method 1400 is identical to method 1300 (FIG. 13) except that step 1440 replaces step 1340 of method 1300. In step 1440, the active spatial light modulator, on which the intermediate image is formed, directs light towards a hyperspectral analyzer according to the selection data received in step 1330. As for step 1340 of method 1300 (FIG. 13), step 1440 utilizes the spatial correspondence between the active spatial light modulator and the field of view, which results from the formation of an intermediate image of the field of view on the active spatial light modulator. Step 1440 includes two steps 1450 and 1480 that achieve multiplexed operation of the hyperspectral analyzer and the alternate analyzer. Steps 1450 and 1480 are identical to steps 1350 and 1380 of FIG. 13 except that in step 1480, light from the selected portion of the field of view is directed towards the alternate analyzer. Thus, light from the same portion of the field of view is directed towards both the hyperspectral analyzer and the alternate analyzer, thereby achieving multiplexed operation of the hyperspectral analyzer and the alternate analyzer.

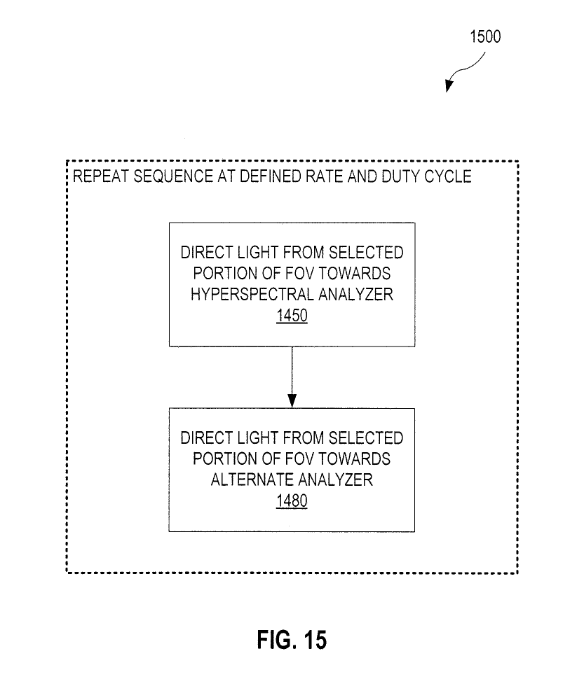

FIG. 15 illustrates a method 1500 for performing step 1440 of method 1400 (FIG. 14). Method 1500 provides temporal multiplexing between the hyperspectral analyzer and the alternate analyzer. In method 1500, step 1450 (FIG. 14) and step 1480 (FIG. 14) are performed in series. This sequence is repeated for a desired duration at a defined repetition rate and duty cycle for spectral or hyperspectral analysis by the hyperspectral analyzer. Consequently, when performing method 1400 of FIG. 14 with step 1440 performed according to method 1500, the active hyperpixel array imaging system alternates between spectral, or hyperspectral, analysis, e.g., by hyperspectral analyzer 114 (FIGS. 1 and 2), and alternate analysis, e.g., by alternate analyzer 270 (FIG. 2).

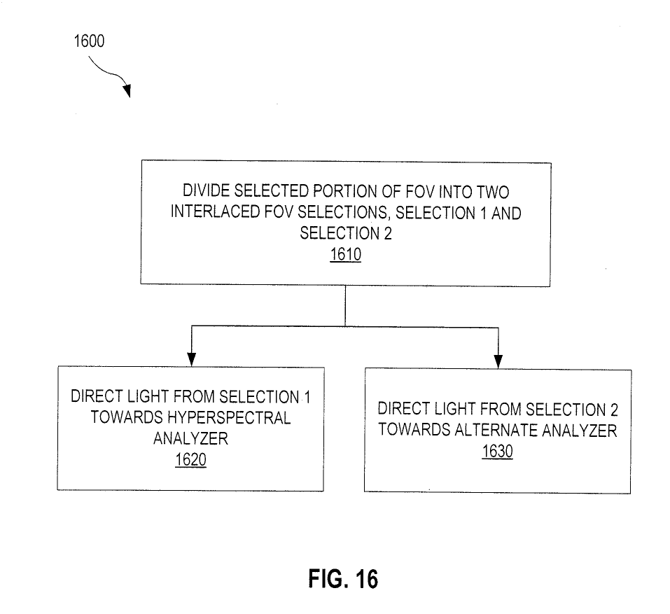

FIG. 16 illustrates a method 1600 for performing step 140 of method 1400 (FIG. 14), which provides spatial multiplexing between the hyperspectral analyzer and the alternate analyzer. In a step 1610, the FOV portion selected in step 1320 is divided into two interlaced FOV selections, selection 1 and selection 2. For example, control system 220 (FIG. 2) performs step 1610 according to instructions 222 (FIG. 2). In a step 1620, light from selection 1 is directed towards the hyperspectral analyzer. Due to the spatial correspondence between the field of view and the active hyperspectral analyzer, through the formation of the intermediate image thereon, selection 1 and selection 2 correspond to two interlaced portions of the active spatial light modulator. Step 1620 is identical to step 1350 (FIG. 13) with the selected portion of the FOV being selection 1. Step 1630 is identical to step 1380 (FIG. 13) with the non-selected portion of the FOV being selection 2.

In an embodiment, the active spatial light modulator used to perform steps 1620 and 1630 includes an array of discrete elements, e.g., array of discrete elements 420, of higher resolution than the underlying resolution of the intermediate image formed thereon. For example, the pitch between discrete elements is less than the radius of the blur spot characteristic of the intermediate image. Selection 1 and selection 2 may be interlaced with a characteristic pitch between selection 1 and selection 2 that is less than the radius of the blur spot. Selection 1 and selection 2 may define, e.g., alternating rows of discrete elements, or alternating discrete elements within one or more rows of discrete elements. With a characteristic pitch between selection 1 and selection 2 less than the radius of the blur spot, the active spatial light modulator maintains the spatial resolution of the intermediate image for both light directed towards the hyperspectral analyzer and light directed towards the alternate analyzer. The resolution of the intermediate image formed on the active spatial light modulator limits the spatial resolution of data recorded by the hyperspectral analyzer and the alternate analyzer.

Methods 1300 (FIG. 13), 1400 (FIG. 14), 1500 (FIG. 15), and 1600 (FIG. 16) may be extended to a plurality of alternate analyzers.

FIG. 17 illustrates an active hyperpixel array imaging system 1700. Active hyperpixel array imaging system 1700 is identical to active hyperpixel array imaging system 200 of FIG. 2, except for the addition of a separate spatial imaging system 1770. Separate spatial imaging system 1770 operates separately from active spatial light modulator 112 and generates spatial imaging data that is communicated to interface 224 of control system 220 as spatial data 1787. Spatial data 1787 is, for example, tracking data for one or more objects of interest. Control system 220 may use such tracking data to control active spatial light modulator 112 according to instructions 222. For example, active spatial light modulator 112 may direct light from one or more FOV portions associated with the respective object of interest towards hyperspectral analyzer 114. This use of separate spatial imaging system 1770 allows for continuously tracking one or more objects moving within the field of view of the hyperpixel array imaging system, and capturing images containing spectral or hyperspectral data while the object is moving. The objects may move at different speeds and in different directions. In comparison, a hyperspectral imaging system, not utilizing tracking, is forced to direct light from all of the field of view towards a hyperspectral analyzer. The present system, utilizing tracking, provides more rapid generation of the desired data and/or reduces the data amount required to obtain the required data. Changes may be made in the above methods and systems without departing from the scope hereof. It should thus be noted that the matter contained in the above description and shown in the accompanying drawings should be interpreted as illustrative and not in a limiting sense. The following claims are intended to cover generic and specific features described herein, as well as all statements of the scope of the present method and system, which, as a matter of language, might be said to fall therebetween.

What is claimed is:

1. An active hyperpixel array imaging system comprising
a hyperspectral analyzer;
an active spatial light modulator dynamically configurable to direct light, from at least a portion of a field of view of the hyperpixel array imaging system, towards the hyperspectral analyzer for capture of a two-dimensional image comprising spectral information; and
imaging optics for forming an intermediate image, of the field of view on the active spatial light modulator.

2. The system of claim 1, the two-dimensional image further comprising spatial information to form a hyperspectral image.

3. The system of claim 2, the hyperspectral analyzer further comprising:
a dispersive optic for spectrally dispersing light to generate spectral information; and
a focal plane array for capturing the two dimensional image.

4. The system of claim 3, the hyperspectral analyzer imaging a spectrum of light, directed thereto from a point on the active spatial light modulator, onto a line on the focal plane array.

5. The system of claim 1, the active spatial light modulator comprising a plurality of discrete elements, each of the plurality of discrete elements being separately, dynamically configurable for redirecting light incident thereupon.

6. The system of claim 5, further comprising a control system for dynamically configuring the plurality of discrete elements.

7. The system of claim 6, the control system comprising:
an interface for receiving positions of one or more objects within the field of view; and
a non-volatile memory comprising machine-readable instructions for defining the at least a portion of a field of view to include one or more portions respectively corresponding to the one or more objects.

8. The system of claim 5, each element of the plurality of discrete elements being electronically, separately, dynamically configurable.

9. The system of claim 5, the plurality of discrete elements being reflective.

10. The system of claim 5, the hyperspectral analyzer reimaging light directed towards the hyperspectral analyzer from a plurality of parallel lines of discrete elements to form a respective plurality of rectangles in the two-dimensional image, a first dimension thereof comprising a spectral decomposition of each discrete element and a second dimension thereof comprising a spatial image of each component of the spectral decomposition.

11. The system of claim 8, the discrete elements of the active spatial light modulator being configured to sequentially direct light from different pluralities of parallel lines of discrete elements towards the hyperspectral analyzer.

12. The system of claim 6, further comprising an alternate analyzer, and wherein the active spatial light modulator is dynamically configurable to direct light from portions of the field of view towards the alternate analyzer or the hyperspectral analyzer.

13. The system of claim 12, the active spatial light modulator being dynamically configurable to continuously alternate between directing light from portions of the field of view towards the hyperspectral analyzer and towards the alternate analyzer.

14. The system of claim 12, the active spatial light modulator being dynamically configurable to direct light from (a) a first array of discrete portions of the active spatial light modulator towards the hyperspectral analyzer and (b) a second array of discrete portions of the active spatial light modulator towards the alternate analyzer, the second array being interlaced with the first array.

15. The system of claim 14,
wherein a spatial resolution of the intermediate image is characterized by a blur spot radius; and
wherein a distance between a discrete portion of the first array and a discrete portion of the second array, closest to the discrete portion of the first array, is a blur spot radius or less.

16. The system of claim 12, the alternate analyzer being a spatial imaging system.

17. The system of claim 16, further comprising:
an interface for receiving, from the spatial imaging system, positions of one or more objects within the field of view; and
a non-volatile memory comprising machine-readable instructions for defining the at least a portion of a field of view to include one or more portions respectively corresponding to the positions.

18. The system of claim 16, the active spatial light modulator being dynamically configured to, at least periodically, direct light from a moving portion of the field of view associated with a moving object towards the hyperspectral analyzer, based upon tracking information from the spatial imaging system.

19. The system of claim 12, the alternate analyzer being an integrating spectral analyzer.

20. A method for performing spectral analysis of a field of view, comprising:
forming an intermediate image of the field of view on an active spatial light modulator;
directing light from at least a portion of the field of view, using the active spatial light modulator, towards a hyperspectral analyzer; and
capturing an two-dimensional image of the portion of the field of view, using the hyperspectral analyzer, the two-dimensional image comprising spectral information for the portion of the field of view.

21. The method of claim 20, the two-dimensional image further comprising spatial information for the portion of the field of view, forming a hyperspectral image.

22. The method of claim 20, the step of directing comprising separately controlling a plurality of discrete elements of the active spatial light modulator.

23. The method of claim 20, the spatial light modulator being reflective.

24. The method of claim 20, further comprising:
directing light from the portion of the field of view, using the active spatial light modulator, towards an alternate analyzer.

25. The method of claim 24, the alternate analyzer being a spatial imaging system.

26. The method of claim 25, further comprising:
determining positions for one or more objects in the field of view using the spatial imaging system; and
defining the at least a portion of the field of view to include portions corresponding to the positions.

27. The method of claim 26, the steps of determining and defining being repeated to track the positions of the one or more objects.

28. The method of claim 24, the alternate analyzer being an integrating spectral analyzer.

29. The method of claim 21,
the steps of directing and capturing being repeated for a plurality of different portions of the field of view to capture a respective plurality of two-dimensional images; and
the method further comprising combining the plurality of two-dimensional images to form a hyperspectral cube for the union of the plurality of different portions of the field of view.

30. The method of claim 29, the plurality of different portions of the field of view corresponding to parallel lines of the intermediate image.

31. The method of claim 29, the plurality of different portions of the field of view corresponding to an array of dots of the intermediate image.

32. The method of claim 20, further comprising:
selecting a second portion of the field of view different from the at least a portion of the field of view; and
directing light from the second portion of the field of view, using the active spatial light modulator, to an alternate analyzer.

33. The method of claim 32, the alternate analyzer being a spatial imaging system.
